(19) United States
(12) Patent Application Publication
(10) Pub. No.: US 2019/0318622 A1
(43) Pub. Date: Oct. 17, 2019

(54) ADVANCED CAMERA NETWORK FOR LICENSE PLATE RECOGNITION

(71) Applicant: Location Services, LLC, Folsom, CA (US)

(72) Inventors: Catherine Shideler, Citrus Heights, CA (US); Nicholas Andrew, Rancho Cordova, CA (US); David Tooby, Wayne, IL (US); Tina Barr, Placerville, CA (US); Shawn White, El Dorado Hills, CA (US); Lee McCarty, Portland, OR (US); Henry Kuo, Huntington Beach, CA (US); Robert Batchko, Torrance, CA (US); Samuel Robinson, Los Angeles, CA (US); Roderick McAfee, Cumming, GA (US); James Jordan, Dacula, GA (US); Steve Gieseking, Suwanee, GA (US)

(21) Appl. No.: 16/385,845

(22) Filed: Apr. 16, 2019

Related U.S. Application Data
(60) Provisional application No. 62/658,563, filed on Apr. 16, 2018.

(51) Int. Cl. G08G 1/017; G06K 9/32; H04N 7/18

(52) U.S. Cl. CPC G08G 1/0175; G06K 2209/15; H04N 7/181; G06K 9/3258

(57) ABSTRACT

Embodiments of the present disclosure are directed at an improved license plate recognition (LPR) device for identifying vehicular information. In some embodiments, the LPR device includes a DC power source for electrically powering the unit, one or more cameras, processors (or computers), circuitry, and programs for processing images/video captured by the one or more cameras to extract license plate information and/or perform other suitable image processing functions within the LPR device in situ, wired and wireless communications for linking multiple such camera units to each other and to a central data base. The cameras may include infrared and/or color sensors and LEDs, rolling or global shutters, and optical filters.

### CROSS-REFERENCE TO RELATED APPLICATION(S)

This application claims the benefit of U.S. Provisional Patent Application Ser. No. 62/658,563, filed on Apr. 16, 2018, entitled “ADVANCED CAMERA NETWORK FOR LICENSE PLATE RECOGNITION,” the disclosure of which is hereby incorporated by reference in its entirety.

### TECHNICAL FIELD

This disclosure is related to automated license plate recognition. More particularly, the embodiments disclosed herein are directed at systems, devices, and methods for recognition of vehicle license plates using a camera-network based configured for remote management and monitoring.

### BACKGROUND

License plate recognition (LPR) (also known as automatic license plate recognition, or ALPR) is a term usually used to describe technology associated with electronically capturing license plate information of vehicles. LPR technology is used by law enforcement for toll road tracking, private/public parking enforcement tracking, banks/financial institutions for repossessing vehicles, and for other purposes. LPR generally involves using a camera to automate the process of taking an image of a license plate of a vehicle captured within a field of view of the camera. This image is processed using software to extract the license plate information (and often the make, model, color and geospatial coordinates of the vehicle) which is then usually saved in a database. Because the image is captured from a distance, factors such as vehicular speed, weather conditions (e.g., fog, night vision, rainy, snow), reflective license plate material, position of camera relative to the vehicle, other obstructions, etc. can adversely affect the quality of the license plate information captured. Further, in some deployments of LPR technologies, legacy controller boxes are employed for enclosing equipment with capturing the images. Not only are these boxes large, bulky and cumbersome to handle, they also utilize technology that is not compatible across different providers. For example, some of these boxes may not have the ability to process the captured images and are thus connected to a computer which performs the image processing tasks. Thus, there is a need for systems and methods for addressing the challenges faced by conventional LPR technology and also able to process the images in situ. This can facilitate realtime identification of a vehicle of interest. Additional deficiencies of current LPR systems include: (a) a limitation on the number of cameras that can be connected to the LPR computer; and (b) the inability to wirelessly distribute the tasks of image capture, image processing and license plate recognition among numerous cameras and computers, i.e., to wirelessly network multiple fixed and mobile cameras and computers.

### SUMMARY

The disclosed ALPR system (also referred to herein as “camera unit” or “LPR device”) comprises multiple vision nodes each of which is an enclosure including: cameras, illumination sources, a processor, and embedded software. Each vision node communicates with other vision nodes and/or a central database via wired or wireless means. Further, the vision nodes may directly communicate with a human interface device such as a smartphone, tablet, or computer. The hardware and software of each vision node enable real-time, image recognition and processing in situ. Any number of vision nodes can function alone or in concert with others to easily expand overall visual coverage.

### BRIEF DESCRIPTION OF THE DRAWINGS

FIG. 1 is an example schematic of a LPR device network.

FIG. 2 is a cross-section view of a vision node (or camera unit).

FIG. 3 is an isometric cutaway view of a vision node (or camera unit).

FIG. 4 is a front view and a vision node (or camera unit).

FIG. 5 is a shaded front view and a vision node (or camera unit).

FIG. 6 is a block diagram of the main components of a vision node (or camera unit).

FIG. 7 is a flowchart of steps of a process implemented by a LPR device.

### DETAILED DESCRIPTION

Embodiments of the present disclosure are directed at an improved LPR device (also referred to herein as a camera unit). In some embodiments, the LPR device includes a DC power source for electrically powering the unit, one or more cameras, processors (or computers), circuitry, and programs for processing images/video captured by the one or more cameras to extract license plate information and/or perform other suitable image processing functions within the LPR device in situ, wired and wireless communications for linking multiple such camera units to each other and to a central data base. Wireless communications may include cellular, WiFi, Bluetooth and any other method known to those skilled in the art. The cameras may include infrared and/or color sensors and LEDs, rolling or global shutters, and optical filters. An illumination system, such as one or more light emitting diodes (LEDs) may be included for illuminating the target (i.e., vehicle and license plate). In some embodiments, the disclosed LPR device includes a Global Positioning System (GPS) module for obtaining information of the vehicle's location. In some embodiments, the location information is stamped along with a date and the time on the extracted license plate information. In some embodiments the LPR information includes make, model and color of the vehicle. If the VIN number of the vehicle is displayed using a medium that may be received by the camera unit (such as but not limited to optical or radio wave transmission) then the LPR information may include the VIN number of the vehicle as well. One patentable benefit of the disclosed LPR device is that the processing of the captured images/video can be done in situ, within the device without the requirement of other devices and without compromising the quality of the extracted information. For example, in some applications, the disclosed camera unit can scan moving vehicles and provide 100% or near 100% accuracy in extracting license plate information for vehicles moving at 45 mph.

It will be understood that the term “camera” (or “camera unit”) as used herein can broadly apply to any type of sensor including audio sensor, environmental sensors that detect the presence of chemicals or gases, can be based on any suitable technology (infrared (“IR”), optical, visible spectrum, etc.), and can be from any manufacturer or vendor. The cameras can all be used in unison or individual cameras can be selected for operation. The cameras can also employ image stabilization techniques to reduce jitter. In applications involving multiple cameras, the cameras can be positioned in an offset manner to broaden the field of view of the capture. There is no limitation on the number of cameras that can be included in the disclosed LPR device.

In some embodiments, the LPR device includes a robust enclosure/housing that can be mounted onto a fixed, static (e.g., on a traffic light, a freeway exit ramp, or at a location close to a toll gate) or a moving platform (e.g., on top of or on the side of a law enforcement vehicle). In some applications, the enclosure can be sturdy and weather-proof to withstand an external environment, if needed.

In some embodiments, the disclosed LPR device includes non-volatile storage memory for locally storing the captured images and/or video. In some embodiments, captured images and/or video can be uploaded to a remote cloud or a physical server, in addition to or in lieu, of the local storage location. Thus, a wireless communication module located within the LPR device can allow communications with a remote server. In some embodiments, the connection between the server and the LPR device can involve a wired, physical connection. As a result of the communications between the LPR device and the server, a user can access historical data stored on the LPR device, such data not necessarily limited to images/videos. For example, information associated with configuring different components of the LPR device, upgrading the software program running on the LPR device, etc. can be sent from the remote server to the LPR device. In some embodiments, the server can communicate with a mobile application program for configuring the LPR device, displaying information stored locally on the LPR device, managing the LPR device, and/or performing suitable operations on the LPR device, such as changing the camera settings or upgrading the firmware of the electronic components included in the LPR device. The mobile application program can run on a mobile device such as a phone, laptop, tablet computer, or a wearable electronic device. The mobile application (e.g., running on a phone or a tablet computer) can thus control/configure operations of the LPR device and the components included therein. In some embodiments, the LPR device can allow manual configuration and management. For example, users can connect the device to an external computer for software installation, diagnostics and configuration of the LPR device. Accordingly, the LPR device can be equipped with micro HDMI and micro USB connectors. In some embodiments, the micro HDMI and micro USB connectors can serve a dual purpose of connecting to another electrical component within the LPR device.

In some applications, the LPR device maintains a “hotlist,” which is a list of vehicular license plate information for vehicles associated with crimes, low-level misdemeanors and traffic offenses. When the LPR device finds a match between the extracted license plate information of a vehicle passing by and a vehicle listed on the hotlist, the LPR device (e.g., the wireless communications module) can send an alert to a law enforcement officer or agency in realtime or near realtime. In some implementations, the LPR device is capable of wirelessly updating the hotlist to locally maintain a current list of wanted vehicles. Non-limiting examples of applications where the hotlist is applicable include repossession of vehicles by financing institutions, law enforcement, etc. The hotlist can be provided by an entity associated with manufacturing the LPR device, law enforcement agencies, or other third parties.

Further, the wireless communication module located within the LPR device can involve Wifi, Bluetooth, 4G/LTE, 5G, or any other form of wireless technology. Also, in some embodiments, extracted license plate information can reveal additional information such as that of the vehicle, the vehicle's drivers and passengers, as well as its immediate surroundings, and possibly even people getting in and out of a vehicle. In some embodiments, artificial intelligence (AI) methodologies, statistical pattern recognition, or other suitable technologies can be included in the extraction of the vehicular license plate information.

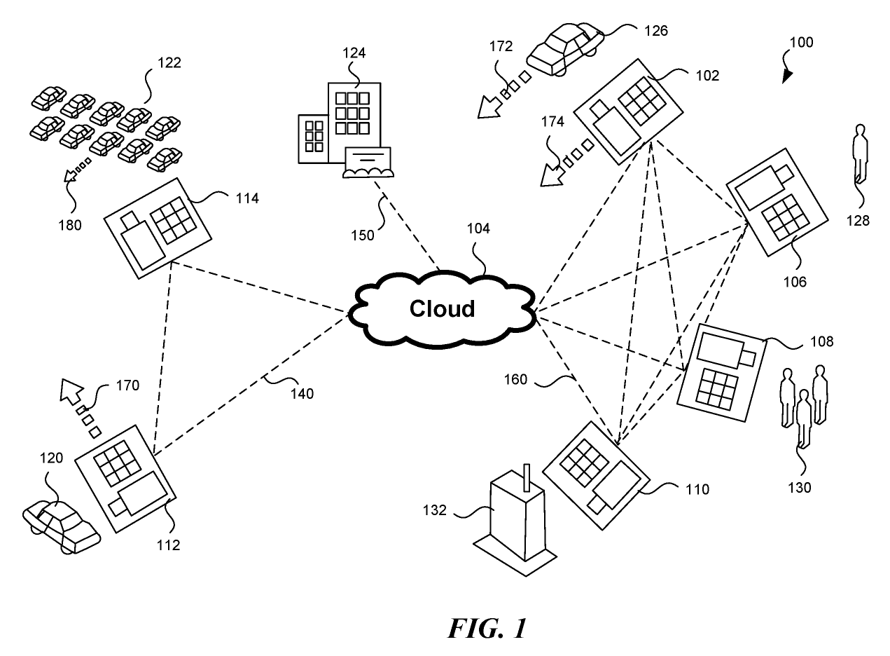

FIG. 1 is a schematic diagram showing distributed vision (or distributed LPR) system 100, comprising vision nodes 102, 106, 108, 110, 112, 114, in communication with each other and cloud 104 via wired or wireless connections. Vision node 102 may be in motion or in a fixed position (as indicated by thick arrow 174) and may capture and/or process images, video, or data of vehicle 126 which may be in motion or in a fixed position (as indicated by thick arrow 172). Vision node 106 may capture and process images, video, or data of a person or object 128. Vision node 108 may capture and process images, video, or data of group of people or objects 130. Vision node 110 may capture and process images, video, or data of a people or objects in or around structure 132. Images, video, or data captured by vision nodes 102, 106, 108 or 110 may be processed in situ and/or transmitted to other devices connected to wired or wireless network 160. Vision node 112 may be in motion or in a fixed position (as indicated by thick arrow 170) and may capture and process images, video, or data of non-moving vehicle 120. Vision node 112 may capture and process images, video, or data of group of vehicles 120. Some vehicles in group of vehicles 120 may be moving (as indicated by thick arrow 180). Data stored on cloud 104 may be transmitted via wired or wireless network 150 to post-processing site 124. Post-processing site 124 can be a physical facility with computers that are connected via wired or wireless network 150 for retrieving captured images and/or results of processing the captured images. In some embodiments, vision node 102 includes a mobile subscriber identification module (SIM) card connected to wireless network 150 (e.g., a cellular or WiMax network). This can provide network connectivity to vision node 102 and also function as a Wifi hub to the vehicle on which vision node 102 is mounted. In some embodiments, vision node 102 includes an external modem for providing network connectivity. As such, vision node 102 can communicate with cloud 104 via wired or wireless network 150.

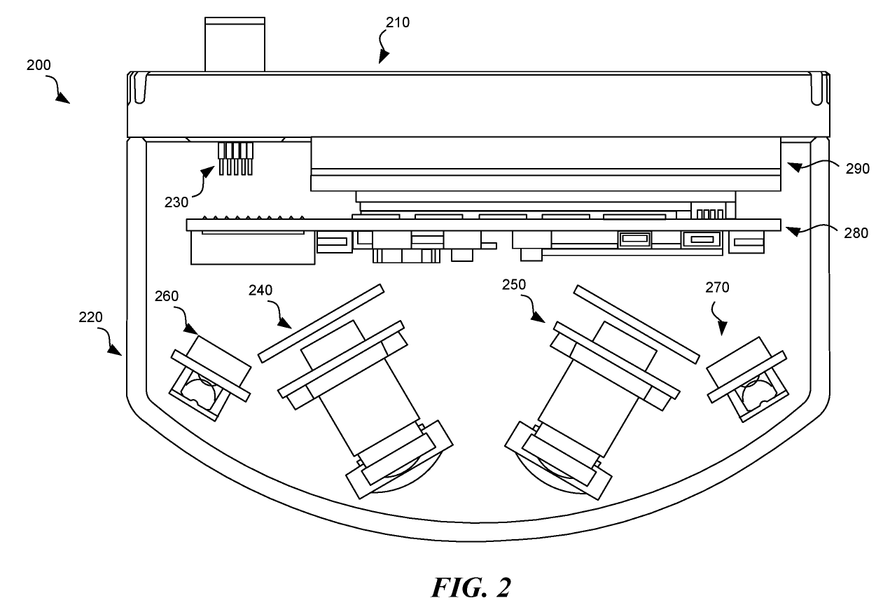

FIG. 2 is a cross-section view of vision node (or camera unit) 200 comprising: back plate 210 and housing 220 including processor 290, carrier board 280, first camera module 240, second camera module 250, first illumination module 260, second illumination module 270 and connector 230. In some embodiments, back plate 210 may be made of a thermally conductive material and intended to dissipate heat from all components of vision node 200. In some embodiments, processor 290 may be a NVIDIA Jetson system on a module (SOM). Carrier board 280 may connect all other components including processor 290, connector 230, first and second camera modules 240, 250 and first and second illumination modules 260, 270. Connector 230 may provide power to vision node 200 and connect vision node 200 to other vision nodes. Processor 290 or carrier board 280 may include Wi-Fi, Bluetooth, and/or cellular connectivity (e.g., to a mobile device such as a phone, a tablet computer, a sensor, or a wearable electronic device). Illumination modules 260, 270 may comprise a printed circuit board (PCB), LEDs, and lenses. In some embodiments, LEDs may emit light in the visible (VIS) or infrared (IR) spectrum. In some embodiment, first illumination modules 260 may be synchronized with first camera module 240 and second illumination modules 270 may be synchronized with second camera module 250. In some embodiments, housing 220 may be made of a transparent or semi-transparent material. In additional embodiments, shroud 510 (not shown) may partially or fully cover the inside of housing 220 and block some spectra of light and allows other spectra to pass. Vision node 200 is powered by a DC power source such as a battery (e.g., internal vehicle battery in a law enforcement vehicle on which vision node 200 is mounted or a portable battery located inside a law enforcement vehicle on which vision node 200 is mounted). The power connection to the DC power source can include options for connecting and disconnecting from the DC power source using an on/off switch, a remote power conditioning unit for remotely operating the DC power source, and/or other features.

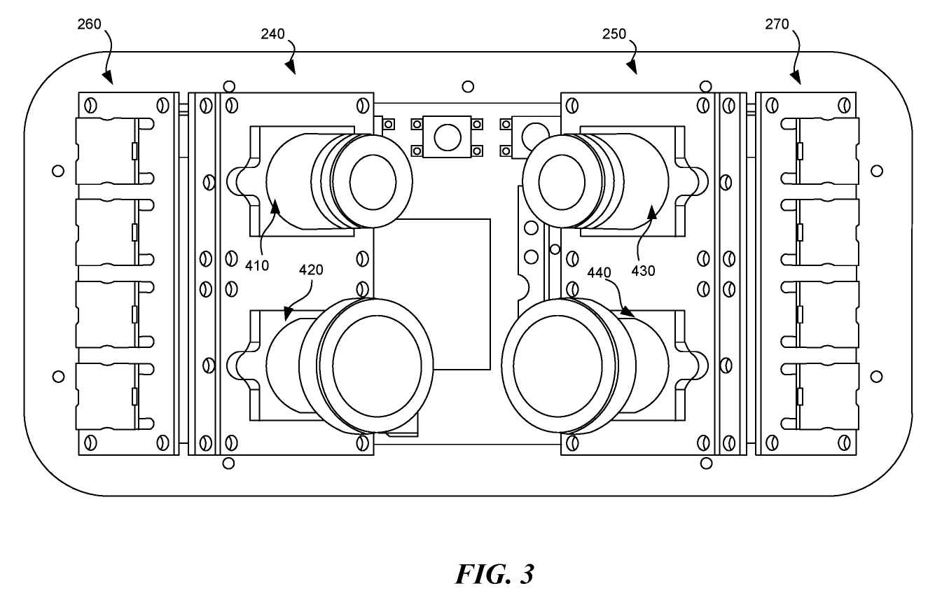

FIG. 3 is a front view of vision node 200. In some embodiments, camera module 240 comprises first camera 410 and second camera 420. Camera module 250 comprises first camera 430 and second camera 440. In some embodiments, first cameras 410 and 430 capture images in a first spectrum of light while second cameras 420 and 440 capture images in a second spectrum of light. In some embodiments first cameras 410 and 430 capture images in the visible spectrum and second cameras 420 and 440 capture images in the infrared spectrum. Thus, cameras in a vision node can selectively allow light of certain wavelengths to pass through while blocking light of other wavelengths. In some embodiments, first cameras 410 and 430 have identical lenses, while in other embodiments they have different lenses. In some embodiments, second cameras 420 and 440 have identical lenses, while in other embodiments they have different lenses. In some embodiments, illumination modules 260 and 270 comprise multiple LEDs and lenses. In some embodiments, illumination modules 260 and 270 emit light in one of the following spectra: UV, VIS, NIR, IR. In some embodiments, the processing of captured images and/or video can be performed by a computer-on-module (COM) inside camera module 240. Thus, one patentable benefit of the present technology is the ability to process images/video in situ within vision node 200.

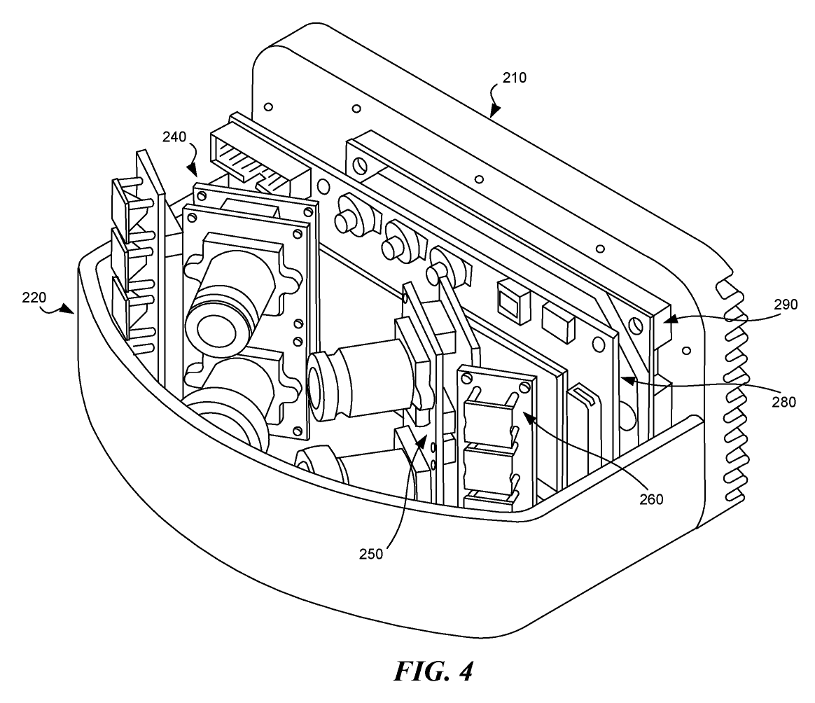

FIG. 4 is an isometric cutaway view of vision node 200. In some embodiments, camera modules 240 and 250 are oriented to capture images of different regions. In other embodiments, camera modules 240 and 250 are oriented to capture images of substantially similar regions.

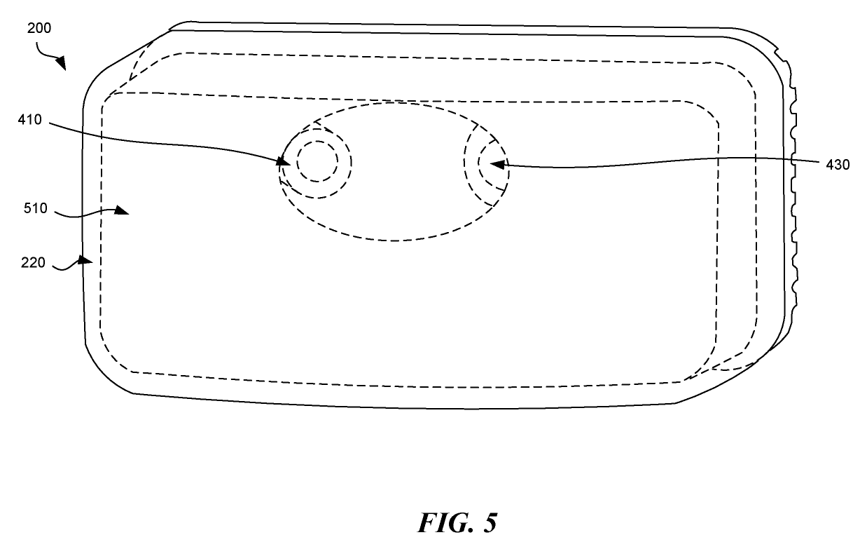

FIG. 5 is an isometric view of vision module 200 with shroud 510 with cutouts for first cameras 410 and 420 is mounted inside housing 220. In some embodiments shroud 510 may also have cutouts for second cameras 420 (not shown) and 440 (not shown). In some embodiments, shroud 510 may allow light at one spectrum, emitted from illumination modules 260 (not shown) and 270 (not shown), to pass while blocking light from other spectra. In such cases, shroud 510 may include a filter/sensor which transmits infrared light while blocking visible light. While the shroud or other filters in the vision node may transmit or block any wavelength of light, it may be desirable for transmitted infrared or near IR (NIR) wavelengths to generally be in the range of 750 to 950 nm and blocked visible wavelengths to generally be in the range of 450 to 650 nm.

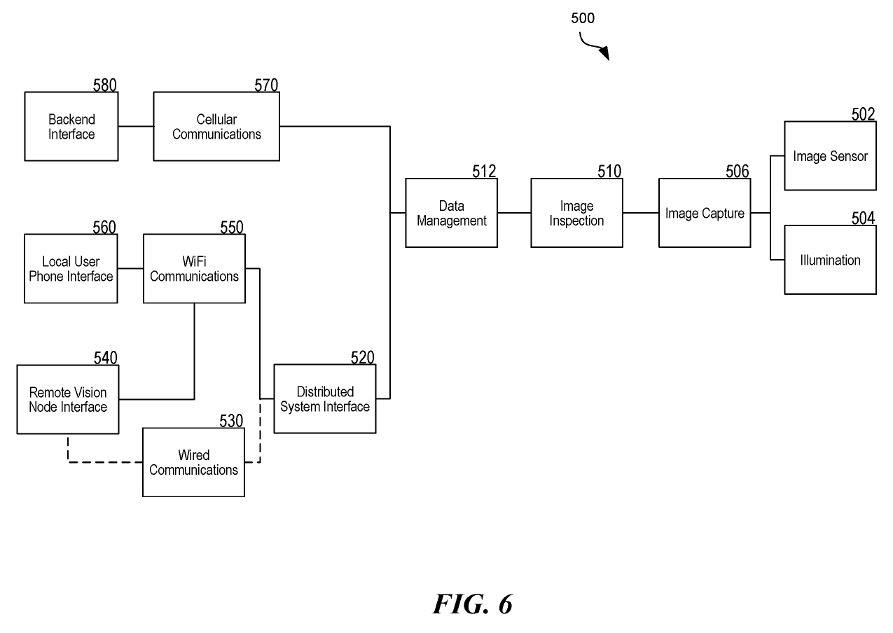

FIG. 6 is a block diagram showing the relationships between functional elements of vision node 200 (not shown). Image sensor 502 and illumination 504 represent cameras and illumination modules in vision node 200. Embedded software installed on the system perform Image Capture 506 and Image Inspection 510 to identify people and objects of interest in captured images. Data Management 512 determines if the captured and processed data is to be uploaded to the cloud via Cellular Communications 570 or transmitted to other vision nodes via Distributed System Interface 520. In some embodiments, data may be transmitted between vision nodes via WiFi Communications 550, and in other embodiments, may be transmitted via Wired Communications 530. Software infrastructure may facilitate Backend Interface 580 with a cloud data base (not shown). In some embodiments, there may be direct interface between vision node 200 (not shown) and a human interface device such as Local User Phone Interface 560. In some embodiments, a software protocol will enable Remote Vision Node Interface 540.

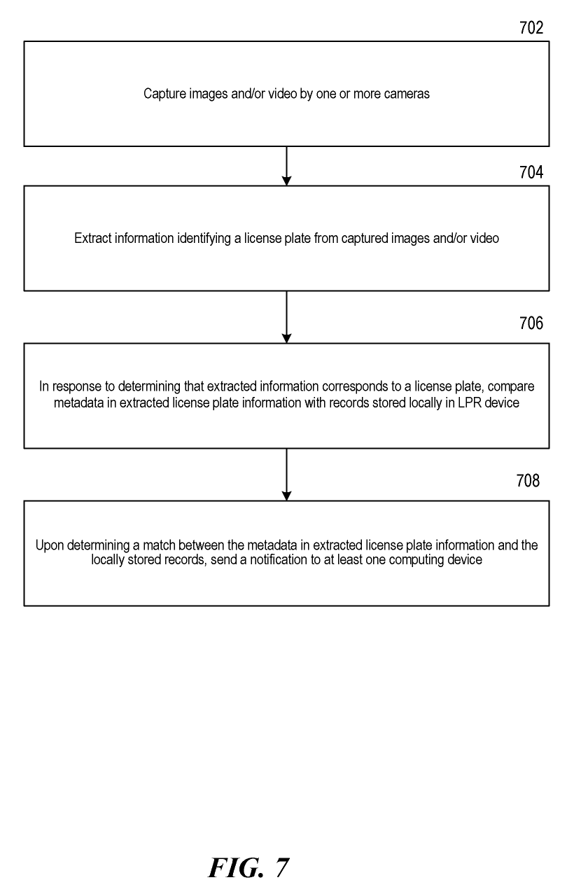

FIG. 7 is a flowchart of steps of a process implemented by a LPR device (e.g., the software configured to run on the LPR device). At step 702, the process captures images and/or video by one or more cameras included in the LPR device. At step 704, the process extracts information identifying a license plate from the captured images and/or video. In response to determining that the extracted information corresponds to a license plate, the process compares (step 706) metadata in the extracted information with records locally stored in the LPR device. The locally stored records can correspond to a list of license plate numbers, and/or other appropriate information. Upon determining a match between the metadata in the extracted license plate information and the locally stored records, the LPR device sends (step 708) a notification to at least one computing device. In some embodiments, the at least one computing device can be a user device (such as a tablet computer, a phone, or a laptop) in a law enforcement vehicle on which the LPR device is mounted. In some embodiments, the notification can be sent to a remote server computer in the cloud. In some embodiments, the notification can be sent to both the user device and the remote server computer. The notification can include the extracted metadata and the outcome of the comparison (e.g., a successful match). The LPR device can be equipped with two network radios, e.g., a long term evolution (LTE) module for cellular connectivity and a Wifi module. As a result of using both network radios, an LPR device can function as a hot-spot, providing network (e.g., Internet) connectivity locally to a user device in a law enforcement vehicle on which the LPR device is mounted. This hotspot is bridged with the LTE module so that the user has network connectivity via the LPR device. This Wifi hotspot capability also allows different components inside the LPR kit to communicate with one other. In some embodiments, the LPR device has “offline capability,” e.g., in an event that network connectivity is lost, the relevant data can be retained in local storage on the LPR device, until such time that the network connectivity is re-established. In some embodiments, the LPR device is configured to periodically check (e.g., with the remote server) wirelessly for new software versions and when a new version is found, the LPR device can automatically installs the latest version without user intervention. The LPR device can be configured to communicate with one or more other LPR devices, e.g., by using the Wifi connection, the LTE module, or both. The other LPR devices can, for example, be attached to law enforcement vehicles or humans located nearby. By sending images and/or videos, the dual wireless network capability allows real time or near real time views of the field of view of the cameras in the LPR device. Thus, a user in a law enforcement vehicle on which the LPR device is mounted can “see” a live view of the camera of the LPR device. Also, personnel located at the remote server can “see” on a graphical user interface (GUI) a live view of the camera of the LPR device. The live view can facilitate calibrating the cameras for optimal operation and efficiency. In addition to wireless capabilities, the LPR device can also include a hardwired Ethernet connection, for network connectivity. The various network connections in the LPR device can allow the one LPR device to communicate with one or more LPR devices, either wirelessly or via a wired connection. It will be understood that although the discussions in FIG. 7 use LTE and Wifi as examples of wireless connection, in other embodiments, different wireless technologies such as WiMax, Bluetooth or other appropriate technology can be employed. Further, in some embodiments, the LPR device can communicate with other LPR devices or law enforcement vehicles, using the Dedicated Short Range Communications (DSRC) wireless communications protocol.

From the foregoing, it will be appreciated that specific embodiments of the invention(s) have been described herein for purposes of illustration, but that various modifications may be made without deviating from the scope of the invention(s) as described in this disclosure or the attached appendix. Accordingly, the invention is not limited except as by the appended claims.

I/We claim:

1. A license plate recognition (LPR) device for capturing vehicular data comprising:
an enclosure at least housing:
one or more cameras for capturing one or more images or videos of a vehicle;
a DC power source for powering the LPR device;
a geographical positioning system (GPS) unit for receiving information relating to a date, a time, and a location of one or more images or videos of the vehicle; and
at least one processor executing instructions for receiving the one or more images or videos of the vehicle to extract license plate information of the vehicle, wherein the license plate information includes the information relating to the date, the time, and the location of the one or more images or videos of the vehicle, wherein the at least one processor is electronically coupled via a first wireless connection to a mobile device.

2. The LPR device of claim 1, wherein the LPR device is configured to communicate the license plate information or the one or more images or videos of the vehicle to at least one remote server via a second wireless connection.

3. The LPR device of claim 1, wherein the LPR device is configured to communicate the license plate information or the one or more images or videos of the vehicle to another LPR device.

4. The LPR device of claim 2, further comprising:
a wireless LTE communications module configured for communicating with the at least one remote server via the second wireless connection.

5. The LPR device of claim 2, wherein the instructions executing in the at least one processor are associated with configuring the LPR device via the first wireless connection or the second wireless connection.

6. The LPR device of claim 1, wherein the one or more cameras selectively allow passage of light of a first wavelength and block passage of light of a second wavelength.

7. The LPR device of claim 1, wherein the LPR device is controlled by an application program on the mobile device.

8. The LPR device of claim 1, wherein the DC power source includes an on/off switch or a remote power conditioning unit for remote operation of the DC power source.

9. The LPR device of claim 1, wherein the one or more cameras for capturing one or more images or videos of a vehicle are configured to be calibrated in real time or near real time.

10. The LPR device of claim 1, wherein the one or more cameras for capturing one or more images or videos of a vehicle are configured to send, via the wireless connection, a live view of the vehicle.

11. The LPR device of claim 1, wherein the first wireless connection includes Wifi technology.

12. The LPR device of claim 1, wherein the instructions executing in the at least one processor are associated with detecting a match between the license plate information of the vehicle and records locally stored in the LPR device.

13. The LPR device of claim 12, wherein the instructions executing in the at least one processor are associated with updating the records locally stored in the LPR device, wherein the records pertain to wanted vehicles relevant to a law enforcement agency or a commercial entity.

14. A system for capturing vehicular data comprising:
a license plate recognition (LPR) device comprising:
an enclosure at least housing:
one or more cameras for capturing one or more images or videos of a vehicle;
a power source for powering the LPR device;
a geographical positioning system (GPS) unit for receiving information relating to a date, a time, and a location of the one or more images or videos of the vehicle;
at least one processor executing instructions for receiving the one or more images or videos of the vehicle to extract license plate information of the vehicle, wherein the license plate information includes the information relating to the date, the time, and the location of the one or more images or videos of the vehicle, wherein the at least one processor is electronically coupled via a first wireless connection to a mobile device; and
at least one remote server communicatively coupled to the LPR device via a second wireless connection.

15. The system of claim 14, wherein the first wireless connection includes Wifi or Bluetooth and the second wireless connection includes long term evolution (LTE) or WiMax.

16. The system of claim 14, wherein the instructions executing in the at least one processor are associated with detecting a match between the license plate information of the vehicle and records locally stored in the LPR device.

17. A license plate recognition (LPR) device network for capturing and transmitting vehicular data comprising:
a first LPR device; and
a second LPR device wirelessly coupled to the first LPR device, wherein the first LPR device and the second LPR device comprise:
an enclosure at least housing:
one or more cameras for capturing one or more images or videos of a vehicle;
a DC power source for powering the LPR device;
a geographical positioning system (GPS) unit for receiving information relating to a date, a time, and a location of the one or more images or videos of the vehicle; and
at least one processor executing instructions for receiving the one or more images or videos of the vehicle to extract license plate information of the vehicle, wherein the license plate information includes the information relating to the date, the time, and the location of the one or more images or videos of the vehicle, wherein the at least one processor is electronically coupled via a first wireless connection to a mobile device.

18. The LPR device network of claim 17, further comprising:
at least one remote server coupled to the first LPR device or the second LPR device via a second wireless connection.

19. The LPR device network of claim 17, wherein the instructions executing in the at least one processor are associated with detecting a match between the license plate information of the vehicle and records locally stored in the LPR device.

20. The LPR device network of claim 19, wherein the instructions executing in the at least one processor are associated with updating the records locally stored in the LPR device, wherein the records pertain to wanted vehicles relevant to a law enforcement agency or a commercial entity.
